(19) United States
(12) Patent Application Publication
(10) Pub. No.: US 2021/0054915 A1
(43) Pub. Date: Feb. 25, 2021

(54) AN ASSEMBLY FOR A DIFFERENTIAL UNIT OF A VEHICLE

(71) Applicant: VOLVO TRUCK CORPORATION, Göteborg (SE)

(72) Inventors: Thomas BARILLOT, Mornant (FR); Serge VANANTY, Chassieu (FR)

(73) Assignee: VOLVO TRUCK CORPORATION, Göteborg (SE)

(21) Appl. No.: 16/963,554

(22) PCT Filed: Apr. 6, 2018
(86) PCT No.: PCT/EP2018/058910

§ 371 Date: Jul. 21, 2020

(51) Int. Cl. F16H 48/24; F16H 48/32

(52) U.S. Cl. CPC F16H 48/24; F16H 48/32

(57) ABSTRACT

The invention relates to an assembly for a differential unit (10) of a vehicle, comprising:—a differential housing (24a) having a longitudinal axis (23);—a differential side gear (18) configured to be connected to a drive shaft (11) capable of being connected to a wheel of a vehicle, the differential side gear being located inside the differential housing and being rotatably mounted relative to the differential housing around the longitudinal axis;—a blocking system (100) for blocking the differential unit operation, comprising a blocking member (50) movable between a released position and a blocking position, and an actuation system (60) for moving the blocking member (50) between said released and blocking positions; wherein the blocking member (50) is located inside the differential housing (24a) and is configured to rotationally secure the differential housing (24a) and the differential side gear (18).

### TECHNICAL FIELD

The invention relates to an assembly for a differential unit of a vehicle. The invention also relates to a differential unit comprising such an assembly, to a driven wheel system comprising such a differential unit and to a vehicle comprising such a driven wheel system.

### BACKGROUND

A vehicle such as a truck is generally equipped with one or several differential units on its driven axles.

A differential unit typically comprises a differential carrier housing which contains the differential mechanism, i.e.: a crown wheel driven by a pinion secured to an input shaft, a differential arranged inside the crown wheel and comprising pinions and gears, and a differential housing arrangement containing the differential and part of drive shafts connected to a wheel of the vehicle. The differential housing arrangement can typically be made of two differential housings each secured to the crown wheel, on both sides thereof, the differential housings thus being mounted in the differential carrier housing.

The differential allows the corresponding left and right wheels to have different speeds when turning/manoeuvring. The maximum torque transfer through a mechanical differential is limited to the lowest wheel adherence. Consequently, if a wheel is spinning typically on a low grip surface such as mud, sand, snow, etc. no torque is transferred to the second wheel and the truck is stuck.

To avoid such a situation, a differential unit can be equipped with a blocking system which makes it possible to block the differential unit operation, and to transfer torque to the wheel still gripping on the ground, thereby allowing the truck to move.

However, the conventional differential units can be fairly bulky, which of course is unfavourable as available space is generally limited in a vehicle.

More specifically, such a blocking system is generally located at one end area of the differential unit, according to the transverse direction of the vehicle, and configured to rotationally secure the drive shaft and the differential housing. This may set some problems, as the transverse width of a vehicle, in particular a truck, is limited to a maximum value given by regulatory requirements. In particular, vehicles having an independent wheel suspension configuration require an increased length in the transverse direction of the vehicle. This means that conventional blocking systems cannot be implemented on a truck having an independent wheel suspension configuration without wheel reduction. Indeed, as the torque to be transmitted by the drive shaft is high, the drive shaft has to be sized accordingly, which is generally not compatible with the regulatory requirements on the vehicle maximum width.

### SUMMARY

An object of the invention is to provide an improved differential unit for a vehicle, in particular a differential unit equipped with a blocking system which is more compact in the vehicle transverse direction.

To that end, and according to a first aspect, the invention concerns an assembly for a differential unit of a vehicle, comprising:
a differential housing having a longitudinal axis;
a differential side gear configured to be connected to a drive shaft capable of being connected to a wheel of a vehicle, the differential side gear being located inside the differential housing and being rotatably mounted relative to the differential housing around the longitudinal axis;
a blocking system for blocking the differential unit operation, comprising a blocking member movable between a released position and a blocking position, and an actuation system for moving the blocking member between said released and blocking positions;

wherein the blocking member is located inside the differential housing and is configured to rotationally secure the differential housing and the differential side gear.

Thus, according to the invention, the rotating components that are rotationally secured to one another for blocking the differential unit operation are the differential side gear and the differential housing, contrary to the prior art.

This allows locating the blocking member inside the differential housing, the invention thus making it possible to save space, in particular in the area adjacent to the differential unit in the transverse direction of the vehicle.

Owing to such an arrangement, the invention makes it possible to implement a blocking system on a differential unit for a heavy-duty vehicle having an independent wheel suspension configuration without wheel reduction. However, the invention is not limited to this application, and can also be used in vehicles having a rigid driven axle.

Another advantage of the invention relies in the fact that the rotationally blocked connections between components of the assembly can be achieved on a larger diameter for example substantially the differential side gear outer diameter than in the prior art typically substantially the drive shaft diameter. This results in smaller forces exerted on the assembly components for a same input torque to transmit through the system. As a consequence, these components can be made of less resistant materials, i.e. less expensive materials, and/or can be under-dimensioned as compared to the prior art, which entails cost savings and increased compactness.

Furthermore, in an implementation, the invention can take advantage of an area of the differential unit in which there is an empty space available for receiving at least part of the actuation system. This area can be substantially facing the differential housing along a direction orthogonal to the longitudinal axis.

The actuation system may comprise:
a connecting device connected to the blocking member in a rotationally and axially fixed manner;
an actuation device capable of moving the blocking member relative to the differential housing between said released and blocking positions, via the connecting device.

It is underlined that, while no rotation and no translation is possible between the connecting device and the blocking member, this does not necessarily means that these two parts are secured to one another.

With a configuration in which:
the blocking member is a rotating component located inside the differential housing;
and the actuation device, which is located outside the differential housing, is preferably rotationally stationary for mounting and connection ease;

the problem raised is solved by the invention owing to the connecting device having an outer portion and a through portion.

The actuation device can be located outside the differential housing and the connecting device can comprise:
an outer portion, mounted on and outside the differential housing, wherein the outer portion is rotationally secured to the differential housing and movable relative to the differential housing along the longitudinal axis, so as to allow the blocking member to be moved between said released and blocking positions;
at least one through portion which extends through a differential housing peripheral wall, in order to fixedly connect the connecting device outer portion and the blocking member, in use.

It has to be noted that the through portion of the connecting device can extend through a cylindrical or radial portion of the differential housing peripheral wall.

“Fixedly connecting” two parts means that these two parts are connected in a rotationally and axially fixed manner. This does not necessarily means that the two parts are secured to one another. Axially and longitudinally both mean: along or parallel to the longitudinal axis.

The blocking member can be rotationally secured to the differential housing and can be movable relative to the differential housing along the longitudinal axis between:
the blocking position, in which the blocking member is engaged with the differential side gear so that the blocking member and differential side gear are rotationally secured to one another;
and the released position, in which the blocking member is spaced apart from the differential side gear.

Rotationally securing the blocking member and differential side gear can be achieved by the cooperation between at least one engagement portion of the blocking member and at least one engagement portion of the differential side gear. These engagement portions can be of any kind, provided they result in the blocking member and the differential side gear being rotationally secured to one another in the engaged position. Preferably, said mutual engagement is achieved by interference.

According to an implementation, the blocking member comprises at least one raised or depressed relief configured to cooperate with at least one corresponding depressed or raised relief provided on the differential side gear in the blocking position. Preferably, the blocking member is ring-shaped and its at least one raised or depressed relief is in the form of a plurality of teeth extending from the periphery of the blocking member, and configured to be engaged in a set of teeth arranged on the differential side gear. Said plurality of teeth preferably extend axially from the periphery of the blocking member. The blocking member then forms a dog clutch. As regards the differential side gear, it can have an annular shape, said set of teeth preferably protruding axially outwardly from one face of the differential side gear opposite the face that comprises a separate set of teeth meshing with at least one differential side pinion of the differential unit.

An inner face of the differential housing may be provided with at least one raised or depressed relief and an outer face of the blocking member may be provided with at least one corresponding depressed or raised relief. Preferably, the inner face of the differential housing and the outer face of the blocking member are provided with corresponding longitudinally extending splines which allow a relative longitudinal sliding movement and prevents a relative rotational movement around the longitudinal axis between the blocking member and the differential housing.

The or each through portion of the connecting device may be engaged in a through opening provided in a peripheral wall of the differential housing, said through portion being capable of axially sliding in said through opening, and being rotatably fixed relative to the differential housing. The through opening is preferably elongated in the longitudinal direction.

The blocking member may comprise at least one receiving portion of the or each through portion of the connecting device, preferably in the form of a through aperture provided in a peripheral wall of the blocking member. Said connecting device through portion is preferably received in said through aperture with no degree of freedom in the longitudinal direction.

The or each through aperture can be elongated circumferentially. This makes the manufacturing and mounting processes easier as no precise relative location of the splines and through aperture(s) is required to make sure that, one the blocking member is mounted inside the differential housing, the connecting device through portion can face a through aperture.

In a variant, the receiving portion does not comprise any aperture. In such a variant, the connecting device through portion can form a single part with the blocking member. It can be made as a single part with the blocking member, or it can be made as a separate part but subsequently permanently or removably secured to the blocking member by any appropriate means such as gluing, welding, screwing or similar.

The outer portion of the connecting device may comprise an inner face provided with at least one raised or depressed relief and an outer face of the differential housing may be provided with at least one corresponding depressed or raised relief, in order to allow a relative longitudinal sliding movement and prevent a relative rotational movement around the longitudinal axis between the differential housing and the outer portion of the connecting device. Preferably, the connecting device inner face comprises at least two protrusions, which are circumferentially spaced relative to one another and which project from the inner face of the connecting device outer portion, and the differential housing outer face comprises at least two cavities which extend axially, which are circumferentially spaced relative to one another and which are arranged on the differential housing outer face. In an embodiment, the cavities may be parallelepiped. Alternatively, the inner face of the connecting device outer portion and the outer face of the differential housing may be provided with corresponding splines.

The outer portion of the connecting device can comprise or be constituted by a ring.

The outer portion of the connecting device can comprise at least one receiving portion of the or each through portion of the connecting device, preferably in the form of a hole or an inner annular groove. Providing a groove is more advantageous than a hole as it facilitates positioning and consequently the mounting process.

Said connecting device through portion is preferably received in said hole or inner annular groove with no degree of freedom in the longitudinal direction.

In a variant, the receiving portion does not comprise any hole or groove. In such a variant, the connecting device through portion can form a single part with the connecting device outer portion. It can be made as a single part with the connecting device outer portion, or it can be made as a separate part but subsequently permanently or removably secured to the connecting device outer portion by any appropriate means such as gluing, welding, screwing or similar.

The outer portion of the connecting device may comprise an outer face provided with an outer annular groove for receiving part of the actuation device. Said part of the actuation device is preferably received in said outer annular groove with no degree of freedom in the longitudinal direction. Alternatively, the outer portion of the connecting device may comprise an outer annular ridge for receiving part of the actuation device, or against which part of the actuation device can be in abutment.

In an implementation, the actuation device and the outer portion of the connecting device are free to rotate around the longitudinal axis relative to one another, the actuation device comprising at least one finger engaged in the outer annular groove of the connecting device outer portion, or one hollow portion for receiving the outer annular ridge of the connecting device outer portion (such as a fork portion contacting opposite annular faces of said ridge). If the outer portion of the connecting device comprises an outer annular ridge, the actuation device preferably comprises a hollow portion for receiving said ridge.

Said finger can move in the groove during the ring rotating movement, and said finger can further move the ring longitudinally. For example, the actuation device can be securely mounted on the differential carrier housing.

According to an embodiment the at least one through portion of the connecting device comprises at least two pins extending radially, preferably four and more preferably eight pins regularly angularly spaced.

The assembly may further comprise a support member configured to be axially maintained between the differential gear and an inner collar of the differential housing, and further forming an inner abutment for preventing a radial inward movement of the or each through portion of the connecting device.

The invention also relates to a differential housing for a differential unit of a vehicle, the differential housing being configured for receiving at least part of a differential, the differential housing having a peripheral wall which has a substantially tubular shape, a longitudinal axis, an inner face and an outer face, the differential housing comprising:
on its inner face, at least one raised or depressed relief for forming an inner sliding connection with a blocking member of the differential unit, along the longitudinal axis, preferably in the form of longitudinal extending splines;
on its outer face, at least one raised or depressed relief forming an outer sliding connection with part of an actuation system of the blocking member, along the longitudinal axis, preferably in the form of at least two circumferentially spaced parallelepiped cavities;
at least one through opening provided in the peripheral wall, configured to form a sliding connection with part of an actuation system of the blocking member, along the longitudinal axis, the through opening(s) being preferably elongated in the longitudinal direction.

This differential housing can be configured to cooperate with a differential side gear and a blocking system for forming an assembly as previously described.

The invention also relates to a differential side gear for a differential unit of a vehicle, the differential side gear having an annular shape and a longitudinal axis, and comprising two opposite faces, the differential side gear being provided with a central hole for receiving in a rotationally fixed manner a drive shaft capable of being connected to a wheel of a vehicle, the differential side gear comprising a first set of teeth for meshing with at least one differential side pinion of the differential unit, the differential side gear further comprising at least one raised or depressed relief, distinct from the first set of teeth or having a different orientation with respect to the first set of teeth, for forming a rotationally coupled connection around the longitudinal axis, preferably between the differential side gear and a blocking member of the differential unit by means of the engagement of a corresponding engagement portion of the blocking member in said at least one raised or depressed relief. This differential side gear can be configured to cooperate with a differential housing and a blocking system for forming an assembly as previously described.

The invention also relates to a blocking member for blocking the operation of a differential unit of a vehicle, the blocking member being configured to be mounted inside a differential housing of the differential unit, the blocking member having a peripheral wall which has substantially the shape of a cylinder having a longitudinal axis, an inner face and an outer face, the blocking member comprising:
on its outer face, at least one raised or depressed relief forming an outer sliding connection along the longitudinal axis, preferably in the form of longitudinal extending splines;
at least one engagement portion for forming a rotationally coupled connection around the longitudinal axis with a differential side gear of a differential unit, said at least one engagement portion being preferably in the form of a plurality of teeth extending from the periphery of the blocking member, for example extending axially;
at least one receiving portion of a part of an actuation system of the blocking member, preferably in the form of a through aperture provided in the peripheral wall.

This blocking member can be configured to cooperate with a differential housing and a differential side gear for forming an assembly as previously described.

The invention also relates to a ring for a blocking system of a differential unit of a vehicle, the ring being configured to be mounted around a differential housing of the differential unit and having a longitudinal axis, an inner face and an outer face, the ring comprising:
on its inner face, at least one raised or depressed relief for forming an inner sliding connection with the differential housing, along the longitudinal axis, preferably in the form of at least two circumferentially spaced protrusions;
on its inner face, at least one receiving portion of a part of an actuation system pertaining to the blocking system, preferably in the form of a hole or an inner annular groove;
on its outer face, an outer annular groove or an outer annular ridge for receiving part of an actuation device pertaining to the blocking system.

This ring can form part of a blocking system configured to cooperate with a differential housing and a differential side gear for forming an assembly as previously described.

According to another aspect, the invention relates to a differential unit of a vehicle, the differential unit comprising a differential carrier housing, and, mounted in said differential carrier housing:
an assembly as previously described;
a crown wheel having a longitudinal axis, arranged to be driven in rotation around said longitudinal axis by an input shaft;
a differential arranged substantially inside the crown wheel and comprising differential side pinions which rotates relative to a joint cross attached to the crown wheel and two differential side gears each connected to at least one differential side pinion and to a drive shaft capable of being connected to a wheel of a vehicle, outside the differential carrier housing;
a differential housing arrangement containing the differential and part of the drive shafts, said differential housing arrangement comprising two differential housings each secured to the crown wheel, on both sides of the crown wheel, the differential housings having the same longitudinal axis as the crown wheel;

wherein one differential housing and the differential side gear located inside said differential housing are part of said assembly.

In an embodiment, the actuation device is mounted on the differential carrier housing, i.e. on the differential carrier housing wall and inside said differential carrier housing, in a rotationally fixed manner.

The blocking system may be located inside the differential carrier housing, in an area substantially facing one differential housing along a direction orthogonal to the longitudinal axis.

The blocking member may be ring-shaped and is preferably arranged around one drive shaft.

The differential unit may further comprise, on either side of the crown wheel, a supporting device which is attached to the differential carrier housing and which comprises a ring-shaped portion in which is received at least part of one drive shaft inside a differential housing and a bearing surrounding the differential housing, the blocking member being located, according to a projection along the longitudinal axis, between the differential side gear and the corresponding bearing.

The invention also relates to a differential unit of a vehicle, the differential unit comprising a differential carrier housing, and, mounted in said differential carrier housing:
a crown wheel having a longitudinal axis, arranged to be driven in rotation around said longitudinal axis by an input shaft;
a differential arranged substantially inside the crown wheel and comprising differential side pinions which rotates relative to a joint cross attached to the crown wheel and two differential side gears each connected to at least one differential side pinion and to a drive shaft capable of being connected to a wheel of a vehicle, outside the differential carrier housing;
a differential housing arrangement containing the differential and part of the drive shafts, said differential housing arrangement comprising two differential housings each secured to the crown wheel, on both sides of the crown wheel, the differential housings having the same longitudinal axis as the crown wheel;
a blocking system for blocking the differential unit operation, comprising a blocking member movable between a released position and a blocking position, and an actuation system for moving the blocking member between said released and blocking positions;

wherein:
the blocking system is located inside the differential carrier housing, in an area substantially facing one differential housing along a direction orthogonal to the longitudinal axis.
and/or the blocking member is configured to rotationally secure the differential housing and the differential side gear.

The invention also relates to a driven wheel system for a vehicle.

According to one embodiment, said driven wheel system comprises at least one left wheel and one right wheel, each wheel being connected to a differential unit as previously described by means of a driveshaft, at least one joint (such as a universal joint, an homocinetic joint, etc.), a lower arm articulated at both ends, and preferably an upper arm articulated at both ends.

According to another embodiment, said driven wheel system forms an axle and comprises:
a differential unit as previously described;
an axle housing which constitute a second housing portion designed to be assembled to a first housing portion for forming the differential carrier housing, and which at least partially contains the drive shafts;
at least one wheel connected to one end of each drive shaft.

The invention also relates to a vehicle comprising at least one driven wheel system as previously described.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a schematic drawing of an underside of a vehicle showing a driven wheel system including a differential unit according to an embodiment of the invention;

FIG. 2 is a schematic view of a first embodiment of a driven wheel system;

FIG. 3 is a schematic view of a second embodiment of a driven wheel system;

FIG. 4 is a perspective view of the differential unit;

FIG. 5 is a perspective and partly cut view of the differential unit, showing an assembly according to an embodiment of the invention, the assembly comprising a differential housing, a blocking member, a differential side gear and a ring;

FIG. 6 is a perspective of the assembly;

FIG. 7 is a perspective and partly cut view of the assembly;

FIG. 8 is a cross section view of the assembly;

FIG. 9 is an exploded view of the assembly of FIG. 7, showing a mounting step of the assembly;

FIG. 10 is a perspective and partly cut view of one differential housing;

FIG. 11 is a perspective view of one differential housing;

FIG. 12 is a perspective view of the blocking member;

FIGS. 13 and 14 are perspective views of the differential side gear from opposite sides;

FIG. 15 is a perspective view of the ring.

### DETAILED DESCRIPTION OF EXAMPLE EMBODIMENTS OF THE INVENTION

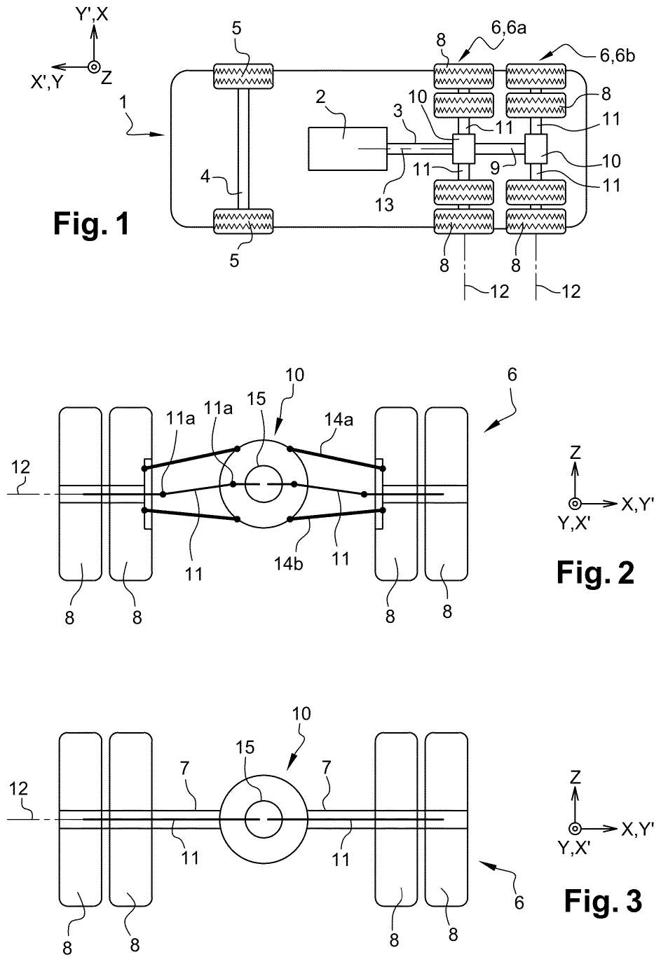

As shown in FIG. 1, a vehicle 1 comprises an engine 2 that drives an input shaft 3 having an axis 13, and a front axle 4 connected to front wheels 5.

The vehicle 1 also comprises at least one driven wheel system 6. The or each driven wheel system 6 has an axis 12, and comprises a differential unit 10, which includes a differential 15, and at least partly two drive shafts 11. Each drive shaft 11 has a first end connected to the differential 15 and a second end connected to at least one wheel 8. In the illustrated embodiment, the vehicle 1 comprises a first driven rear wheel system 6a and a second driven rear wheel system 6b located rearwards from the first driven rear wheel system 6a. Each rear wheel system 6a, 6b can comprise two wheels 8 on either side, thus forming a dual mounted tires arrangement.

An additional shaft 9 connects the input shaft 3 to the differential unit 10 of the second driven rear wheel system 6b, through the differential unit 10 of the first driven rear wheel system 6a, and is the input shaft for the differential unit 10 of the second driven rear wheel system 6b.

The invention is of particular interest for a vehicle having an independent wheel configuration, as schematically illustrated in FIG. 2. In such a configuration, the left wheel(s) 8 and the right wheel(s) 8 are each connected to the differential unit 10 by means of the driveshaft 11, at least one joint 11 a (such as a universal i.e. a cardan joint, or another kind of joint), a lower arm 14b articulated at both ends, and preferably an upper arm 14a articulated at both ends.

However, the invention can also be used for a vehicle having a rigid axle configuration, as schematically illustrated in FIG. 3. In such a configuration, the driven wheel system forms an axle which comprises an axle housing 7 containing the differential 15 and part of the drive shafts 11. The axle housing 7 can constitute a second housing portion designed to be assembled to a first housing portion for forming a differential carrier housing.

The invention can be applied in heavy-duty vehicles, such as trucks, buses and construction equipment, as well as medium-duty vehicles. Although the following description is made with reference to a rear wheel system, it has to be noted that the invention can be used on another driven wheel system, for example on a driven front wheel system.

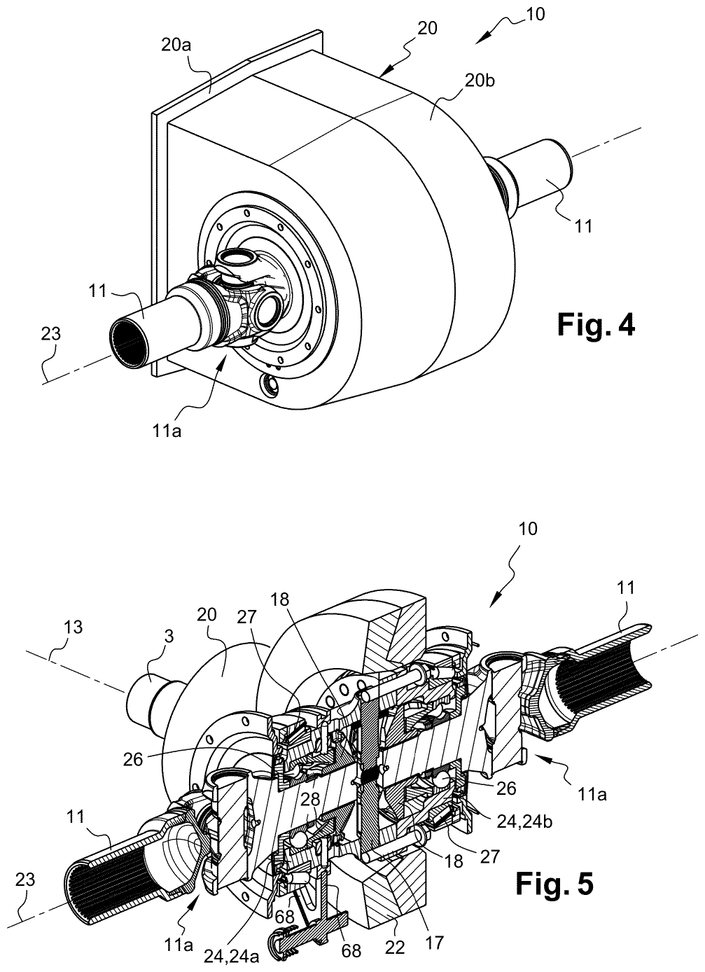

Reference is now made to FIGS. 4, 5 and 8.

The differential unit 10 comprises a differential carrier housing 20, which can made of a first housing portion 20a and a second housing portion 20b (shown in FIG. 4) secured to one another by means of appropriate fasteners (not shown). In a vehicle having a rigid axle configuration, the second housing portion 20b can be formed by the axle housing 7 (see FIG. 3).

Inside the differential carrier housing 20 is located a crown wheel 22 having a longitudinal axis 23. The crown wheel 22 is driven in rotation around said longitudinal axis 23 by the input shaft 3, by engagement of teeth arranged on a pinion (not shown) mounted on said input shaft 3 and teeth arranged on the crown wheel 22 (not shown).

As shown in FIG. 8, the longitudinal direction X is defined as a direction parallel to the longitudinal axis 23 of the crown wheel 22. In the operating position, i.e. when the differential unit is mounted under the vehicle 1, as shown in FIG. 1, the longitudinal direction X corresponds the transverse direction Y′ of the vehicle 1, i.e. the axes 12 of the driven wheel systems 6. Direction X is substantially horizontal when the vehicle 1 is on a horizontal surface.

Besides, the transverse direction Y is defined as the direction which is orthogonal to the longitudinal direction X and substantially horizontal when the vehicle 1 is on a horizontal surface. Direction Y corresponds the longitudinal direction X′ of the vehicle 1. The axis 13 of the input shaft 3 is parallel to the transverse direction Y, i.e the longitudinal direction X′ of the vehicle 1.

Moreover, direction Z is defined as the vertical direction when the vehicle 1 is on a horizontal surface.

The invention will be described when the vehicle 1 is on a horizontal surface.

Inside the crown wheel 22 is arranged a differential 15 which comprises differential side pinions 16, for example four differential side pinions, which are fitted on a joint cross 17 attached to the crown wheel 22, and two differential side gears 18. Each differential side gear 18 meshes with at least one differential side pinion 16 and is fastened to a first end of one of the drive shafts 11. The differential side pinions 16 are not illustrated in FIG. 5; they are illustrated in FIG. 8.

The differential unit 10 further comprises, inside the differential carrier housing 20, a differential housing arrangement 24 which contains the differential 15 and part of the drive shafts 11, namely the part of each drive shaft 11 which is located near the first end of said drive shaft 11. The differential housing arrangement 24 is secured to the crown wheel 22. It may be made of two parts, namely two differential housings 24a, 24b each forming a sleeve around the corresponding differential side gears 18 and partly around the drive shaft 11, said differential housings 24a, 24b being fastened on both sides of the crown wheel 22.

Thus, on each side of the crown wheel 22, the differential side gear 18 is mounted at the first end of the drive shaft 11 in a rotationally fixed manner. Furthermore, both the differential side gear 18 and the drive shaft 11 are rotatably mounted relative to the differential housing 24a, 24b around the longitudinal axis 23. A bearing 26 can be mounted around the drive shaft 11, between the drive shaft 11 and the differential housing 24a, 24b.

The crown wheel 22, differential 15, and differential housing 24 are rotating parts inside and with respect to the differential carrier housing 20. They are mounted on the inner side of the differential carrier housing 20 by means of two supporting devices 30, arranged on both sides of the crown wheel 22. Each supporting device 30 is attached to the differential carrier housing 20 and comprises a ring-shaped portion in which is received part of one drive shaft 11 inside a differential housing 24a, 24b and a bearing 27 surrounding the differential housing 24a, 24b. More specifically, the bearing 27 can have an inner ring mounted on the differential housing 24a, 24b and an outer ring mounted on the supporting device 30. The bearings 27 are preferably conical bearings.

The differential unit 10 further comprises a blocking system 100 (see FIG. 8) for blocking the differential unit operation. The blocking system 100 comprises a blocking member 50 movable between a released position and a blocking position, and an actuation system 60 for moving the blocking member between said released and blocking positions.

The whole blocking system 100 can be located inside the differential carrier housing 20. The blocking system 100 can be located in an area substantially facing one differential housing along a direction orthogonal to the longitudinal axis 23, preferably facing the differential housing 24a that does not extend inside the crown wheel 22.

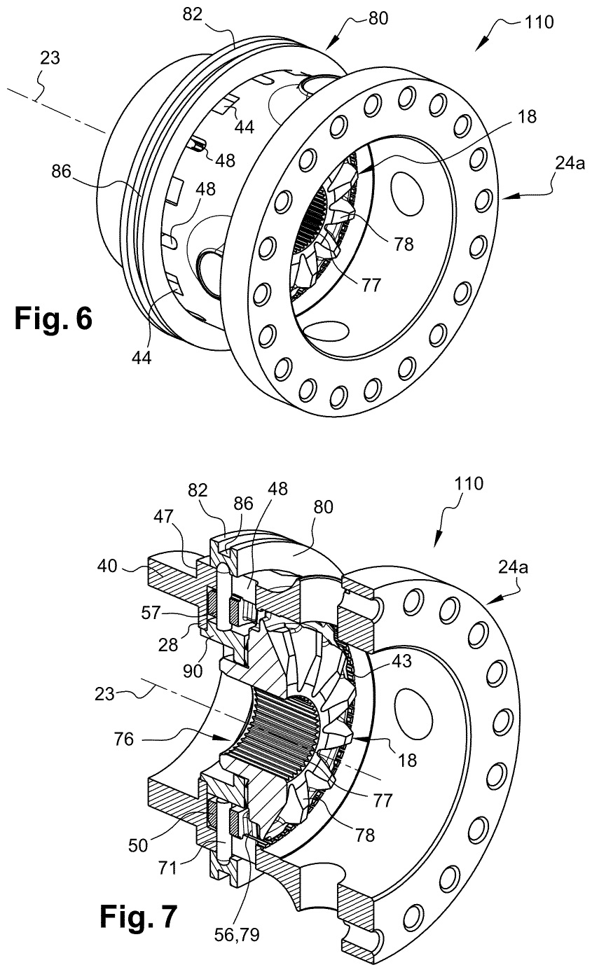

The differential housing 24a, differential side gear 18 and blocking system form an assembly 110 as shown in FIGS. 6 and 7 for example.

According to the invention, the blocking member 50 is located inside the differential housing 24a and is configured to rotationally secure said differential housing 24a and the corresponding differential side gear 18, i.e. the differential side gear 18 located in said differential housing 24a.

The blocking member 50 may be ring-shaped, with a peripheral wall 51 having substantially the shape of a cylinder. The blocking member 50 is preferably arranged around one drive shaft 11. The blocking member 50 may be located, according to a projection along the longitudinal axis 23, between the differential side gear 18 and the corresponding bearing 27 which is mounted between the supporting device 30 and the differential housing 24a.

As shown on FIG. 8, the actuation system 60 may comprise:
a connecting device 70 connected to the blocking member 50 in a rotationally and axially fixed manner;
an actuation device 65 capable of moving the blocking member 50 relative to the differential housing 24a between said released and blocking positions, via the connecting device 70.

In an embodiment, the actuation device 65 can be located outside the differential housing 24a. Then, the connecting device 70 comprises:
an outer portion 80, mounted on and outside the differential housing 24a, said outer portion 80 being rotationally secured to the differential housing 24a and movable relative to the differential housing 24a along the axis 23, so as to allow the blocking member 50 to be moved between said released and blocking positions;
at least one through portion 71 which extends through the peripheral wall of the differential housing 24a, in order to fixedly connect the outer portion 80 of the connecting device 70 and the blocking member 50, in use.

“Fixedly connecting” two parts means that these two parts are connected in a rotationally and axially fixed manner. This does not necessarily means that the two parts are secured to one another.

Owing to this arrangement, the invention makes it possible to transfer an actuation movement from a non rotating component (namely the actuation device 65) to a moving blocking member 50 surrounded by a rotating differential housing 24a. Having a non rotating actuation device 65 makes the implementation simpler, as wires and pipes can be easily connected.

The blocking member 50 can be rotationally secured to the differential housing 24a and can be able to move relative to the differential housing 24a along the longitudinal axis 23:
between the released position, in which the blocking member 50 is spaced apart from the differential side gear 18;
and the blocking position, in which the blocking member 50 and the differential side gear 18 are rotationally secured to one another by the cooperation between at least one engagement portion of the blocking member 50 and at least one engagement portion of the differential side gear 18. In the blocking position, the differential housing 24a and the differential side gear 18 rotate at the same speed around the longitudinal axis 23, and the differential 15 is thus locked.

“Rotationally secured” means that the blocking member 50 is mounted in a rotationally fixed manner relative to the differential side gear 18.

In other words, according to the invention, the differential unit operation is blocked by blocking the rotation between the differential side gear 18 and the differential housing 24a, which results in indirectly blocking the rotation between the drive shaft 11 and the crown wheel 22.

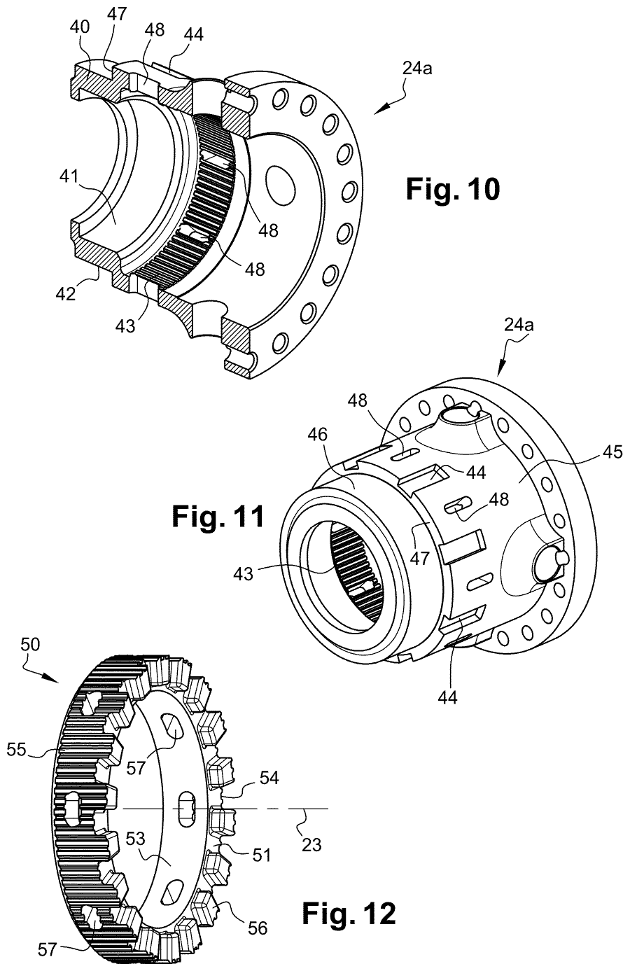

As shown on FIGS. 6 to 11, the differential housing 24a can have a peripheral wall 40 having a substantially tubular shape, generally not with a constant diameter. Said differential housing 24a has the same longitudinal axis 23 as the crown wheel 22 in the mounted position; it further has an inner face 41 and an outer face 42. As illustrated in FIG. 10, the differential housing 24a can be made of two semi tubular half shells which are assembled along a plane that contains the longitudinal axis 23.

On the inner face 41, the differential housing 24a can comprise means for forming an inner sliding connection with the blocking member 50 along the longitudinal axis 23. These means can comprise at least one raised or depressed relief, for example longitudinal extending splines 43.

A “sliding connection” between two parts is a connection that allows a relative sliding movement of said parts along the longitudinal axis 23, but prevents a relative rotation movement between said parts around this longitudinal axis 23.

On the outer face 42, the differential housing 24a can comprise means for forming an outer sliding connection along the longitudinal axis 23 with part of the actuation system 60, more specifically with the outer portion 80 of said actuation system 60. These means can comprise at least one raised or depressed relief. In an embodiment, these means can be in the form of at least two circumferentially spaced cavities 44. The cavities 44 can be parallelepiped. There may be provided at least four, more preferably eight, cavities preferably regularly angularly spaced on the outer face 42 of the differential housing 24a. Alternatively, the differential housing 24a could be provided with outer splines and the actuation system outer portion 80 could be provided with corresponding inner splines.

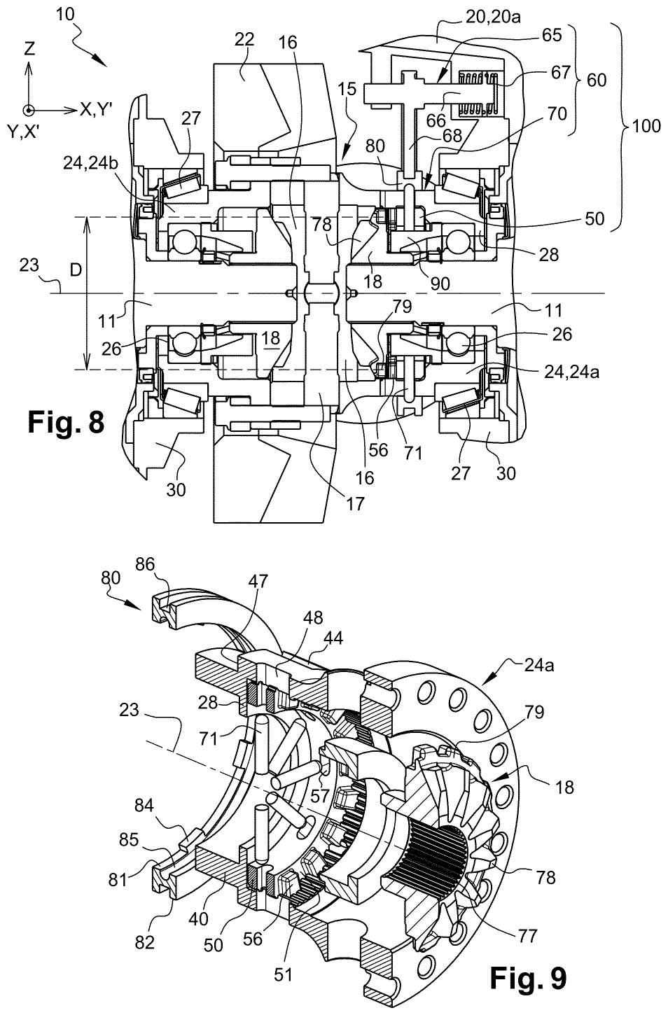

As shown in FIG. 11, the differential housing 24a may have a portion 45, on the crown wheel side, having a larger diameter than another portion 46, and forming a shoulder 47. The cavities 44 may be arranged on said portion 45 having a larger diameter, and may open in the shoulder 47. This allows mounting the outer portion 80 of the connecting device 70 by a sliding movement along the longitudinal axis 23, from the position illustrated in FIG. 9.

The differential housing 24a can comprise at least one through opening 48 provided in the peripheral wall 40. The or each through opening 48 is configured to form a sliding connection along the longitudinal axis 23 with part of an actuation system 60 of the blocking member 50, more specifically with the through portion 70 of said actuation system 60. The or each through opening 48 is preferably elongated in the longitudinal direction X. There may be provided at least four, more preferably eight, through openings 48 preferably regularly angularly spaced on the outer face 42 of the differential housing 24a. Each through opening 48 can be located between two adjacent cavities 44.

As shown on FIG. 12, the blocking member 50 may have a substantially cylindrical peripheral wall 51, and has the same longitudinal axis 23 as the crown wheel 22 in the mounted position. Said blocking member 50 further has an inner face 53 and an outer face 54.

On its outer face 54, the blocking member 50 may have longitudinal extending splines 55 for cooperation with the spline 43 of the differential housing 24a, or another means for providing a sliding connection between the blocking member 50 and the differential housing 24a, along the longitudinal axis 23.

The blocking member 50 may further have at least one engagement portion for forming a rotationally coupled connection around the longitudinal axis 23 with the differential side gear 18. Preferably, this engagement portion is in the form of a plurality of teeth 56 which extend from the periphery of the blocking member 50. The teeth 56 may extend axially from the periphery of the blocking member 50; they can have a parallelepiped shape. In other words, the blocking member 50 can be a dog clutch.

The peripheral wall 51 of the blocking member 50 can also comprise at least one through aperture 57 for receiving part of an actuation system 60 of the blocking member 50, more specifically the through portion 70 of said actuation system 60. There may be provided at least four, more preferably eight, through apertures 57, preferably regularly angularly spaced on the peripheral wall 51 of the blocking member 50. Preferably the through apertures 57 are elongated circumferentially.

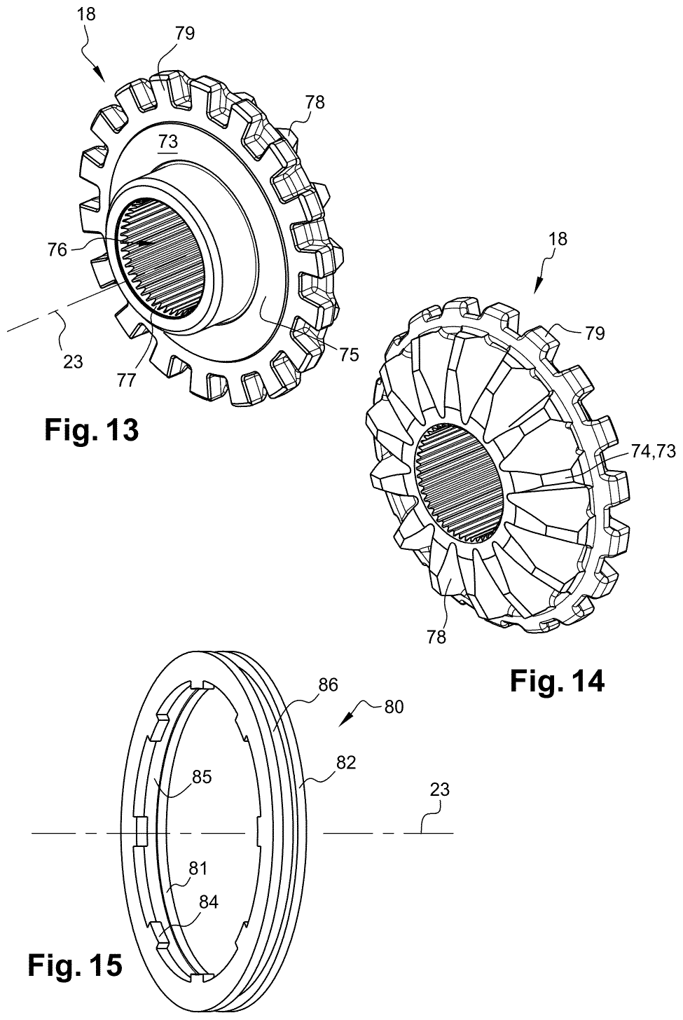

As shown on FIGS. 13 and 14, the differential side gear 18 preferably has an annular shape. It can comprise a disc-shaped plate 73 having two opposite faces, namely one face 74 facing the crown wheel 22 and an opposite face 75. The differential side gear 18 has the same longitudinal axis 23 as the crown wheel 22 in the mounted position.

The differential side gear 18 is provided with a central hole 76 for receiving the drive shaft 11 in a rotationally fixed manner. To that end, the central hole 76 can comprise inner longitudinally extending splines 77. On the face 74 facing the crown wheel 22, the differential side gear 18 comprises a first set of teeth 78 for meshing with at least one differential side pinion 16 of the differential unit 10.

Furthermore, the differential side gear 18 can comprise a second set of teeth 79, which preferably protrude outwardly from a peripheral region of the differential gear 18 and axially from the face 75, for engagement with the teeth 56 of the blocking member 50. Alternatively, the differential side gear 18 and the blocking member 50 could be provided with other complementary engagement portions for forming a rotationally coupled connection around the longitudinal axis 23 between the differential side gear 18 and the blocking member 50. Preferably, said engagement can be achieved by interference, for example between complementary raised or depressed reliefs.

Providing the teeth 79 cooperating with the blocking member 50 on the differential side gear 18 is advantageous. Indeed, first of all, it takes benefit of the fact that the differential side gear 18 is made of a high grade material. Consequently, there is no need to make a surface treatment for having a high resistance of the teeth 79, nor to provide a separate piece made of a high grade material for forming the teeth 79. Secondly, this makes it possible to manufacture the whole differential side gear 18, including the teeth 79 of the second set, in one and the same operation of precision forging. Said precision forging is the current manufacturing process of conventional differential side gear 18 provided with the first set of teeth 78. As no additional manufacturing step is needed, the invention does not involve additional costs.

An embodiment of the outer portion 80 of the connecting device 70 is shown in FIG. 15.

According to this non limiting embodiment, said connecting device outer portion 80 comprises or forms a ring having an inner face 81 and an outer face 82. The ring is configured to be mounted around the differential housing 24a. The ring has the same longitudinal axis 23 as the crown wheel 22 in the mounted position.

On its inner face 81, the ring 80 can comprise at least two circumferentially spaced protrusions 84 capable of sliding longitudinally in the cavities 44 of the differential housing 24a. Alternatively, there could be provided other means for forming an inner longitudinal sliding connection with the differential housing 24a. The protrusions 84 may be parallelepiped, with a longitudinal dimension lower than the longitudinal dimension of the cavities 44, so that the sliding movement can be guided on the whole range of movement. The transverse dimension of the protrusions 84 may be substantially identical to the transverse dimension of the cavities 44 (with an operational clearance) to prevent relative rotation.

Still on its inner face 81, the ring 80 can comprise an inner annular groove 85 for receiving part of the actuation system 60, more specifically the through portion 70 of the connecting device 70 of said actuation system 60. Alternatively, the inner annular groove 85 could be replaced by a hole, as said through portion 70 and said ring 80 are rotationally secured to one another, or another receiving portion.

On its outer face 82, the ring 80 can comprise an outer annular groove 86 for receiving part of the actuation device 65. Alternatively, the ring 80 can comprise an outer annular ridge for receiving part of the actuation device 65.

The actuation device 65 may comprise a hydraulic actuator 66 or any other actuator, and a spring 67 for biasing the actuation device towards the released position. The actuation device 65 is preferably mounted on the differential carrier housing wall, inside the differential carrier housing 20, in a rotationally fixed manner. Such a configuration is simpler, especially regarding the mounting and sealing of pipes provided for carrying an actuating fluid. With this configuration, the connecting device outer portion 80 is a rotating part relative to the actuation device 65.

The actuation device 65 may comprise at least one finger 68 engaged in the outer annular groove 86 of the connecting device outer portion 80, so that the actuation device 65 and the outer portion 80 of the connecting device 70 are free to rotate around the longitudinal axis 23 relative to one another. However, preferably, no relative longitudinal sliding is possible, so that the actuation device 65 longitudinal movement results in the same longitudinal movement of the connecting device outer portion 80, between the released and blocked positions of the blocking member 50. If the ring 80 comprises an outer annular ridge instead of an outer annular groove, the actuation device 65 may comprise a hollow portion for receiving said ridge.

In an embodiment, the through portion 71 of the connecting device 70 comprises at least two pins extending radially, preferably four and more preferably eight pins regularly angularly spaced.

Each through portion 71, i.e. each pin 71, is engaged:
in the inner annular groove 85 of the ring 80, with no degree of freedom in the longitudinal direction X;
in one through opening 48 provided in the differential housing peripheral wall 40, said pin 71 being capable of axially sliding in said through opening 48 as it is elongated, but being rotatably fixed relative to the differential housing 24a, for example because the transverse dimension of the pin 71 is substantially identical to the transverse dimension of the through opening 48;
and in one through aperture 57 provided in the blocking member peripheral wall 51, with no degree of freedom in the longitudinal direction X.

The blocking member 50 is therefore fixedly connected to the connecting device outer portion 80. As a consequence, the actuation device 65 longitudinal movement results in the same longitudinal movement of the blocking member 50, between the released and blocked positions of the blocking member 50. In the mounted position, the blocking member 50 and outer portion 80 are substantially facing each other along a radial direction (i.e. a direction orthogonal to the longitudinal axis 23).

The pins 71 act as pieces that transfer the movement of the connecting device outer portion 80 to the blocking member 50. However, they do not transfer the torque, and are only subjected to the pushing force of the actuation device 65, which is significantly lower than the torque. Consequently, the pins 71 or other through portion is not required to be dimensioned to withstand large efforts.

The longitudinal movement of the blocking member 50 is stopped in both directions. This can be achieved either by abutments cooperating with the blocking member 50 itself, or by limiting the stroke of the actuation device 65.

In case the pins 71, or other connecting device through portions, are not secured to the connecting device outer portion 80 and/or to the blocking member 50, the assembly 110 may comprise a support member 90 (see FIG. 7) forming an inner abutment for preventing a radial inward movement of the or each through portion 71 of the connecting device 70. It has to be noted that, in an embodiment in which the through portion(s) 71 is (are) secured to the outer portion 80 and/or to the blocking member 50, there is no need for such an inner abutment for the through portion(s) 71. The support member 90 may be axially maintained between the differential side gear 18 and an inner collar 28 of the differential housing 24a. The bearing 26 may be located between said inner collar 28 and the differential side gear 18, as shown in FIG. 5. However, other implementation can be envisaged regarding the location of the bearing 26. In a vehicle having an independent wheel configuration, the bearing 26 can be omitted, as it can be replaced by the wheel hub bearing.

As shown in FIG. 8, the mechanical connections between the rotating components of the assembly 110 are made through the splines and teeth on a diameter D which is fairly high, and higher than in the prior art, which increases the resistance of the assembly components to a determined torque.

A trend in heavy duty transport industry is to move from rigid axles to independent wheel suspension (IRS), to improve several features (dynamic behavior, volume capacity for battery/fuel . . . , wheel alignment, comfort . . . ). In an IRS arrangement, for mechanical strength reasons, for providing enough space to allow operational movements of the components, and for improving fuel efficiency, the drive shafts must have a minimum length that may not be easily compatible with the legal constraints, namely the regulatory maximum transverse length of the vehicle.

The invention gives a solution for implementing a differential unit with a blocking system on a vehicle having an IRS arrangement, with dual mounted tires and without wheel reduction, by providing a differential unit having a smaller dimension in the transverse direction of the vehicle.

The invention advantages are all the more significant as IRS is a key solution to develop an optimized electrified driveline, which is a promising development in transportation industry.

Although the invention has been described for a rear wheel system, it can be used in another driven wheel system, especially in a front driven wheel system. Besides, the vehicle can have a different configuration than the one illustrate in FIG. 1. In particular, the invention can be applied to an electric vehicle.

It is to be understood that the present invention is not limited to the embodiments described above and illustrated in the drawings; rather, the skilled person will recognize that many changes and modifications may be made within the scope of the appended claims.

1. An assembly for a differential unit of a vehicle, comprising:
a differential housing having a longitudinal axis,
a differential side gear configured to be connected to a drive shaft capable of being connected to a wheel of a vehicle, the differential side gear being located inside the differential housing and being rotatably mounted relative to the differential housing around the longitudinal axis;
a blocking system for blocking the differential unit operation, comprising a blocking member movable between a released position and a blocking position, and an actuation system for moving the blocking member between said released and blocking positions;
characterized in that the blocking member is located inside the differential housing and is configured to rotationally secure the differential housing and the differential side gear.

2. The assembly according to claim 1, characterized in that the actuation system comprises:
a connecting device connected to the blocking member in a rotationally and axially fixed manner;
an actuation device capable of moving the blocking member relative to the differential housing between said released and blocking positions, via the connecting device.

3. The assembly according to claim 2, characterized in that the actuation device is located outside the differential housing and in that the connecting device comprises:
an outer portion, mounted on and outside the differential housing, wherein the outer portion is rotationally secured to the differential housing and movable relative to the differential housing along the longitudinal axis, so as to allow the blocking member to be moved between said released and blocking positions;
at least one through portion which extends through a differential housing peripheral wall, in order to fixedly connect the connecting device outer portion and the blocking member, in use.

4. The assembly according to claim 1, characterized in that the blocking member is rotationally secured to the differential housing and movable relative to the differential housing along the longitudinal axis between:
the blocking position, in which the blocking member is engaged with the differential side gear so that the blocking member and differential side gear are rotationally secured to one another;
and the released position, in which the blocking member is spaced apart from the differential side gear.

5. The assembly according to claim 1, characterized in that the blocking member comprises at least one raised or depressed relief configured to cooperate with at least one corresponding depressed or raised relief provided on the differential side gear in the blocking position, preferably in the form of a plurality of teeth extending from the periphery of the blocking member, with the blocking member being ring-shaped, and configured to be engaged in a set of teeth arranged on the differential side gear.

6. The assembly according to claim 1, characterized in that an inner face of the differential housing is provided with at least one raised or depressed relief and an outer face of the blocking member is provided with at least one corresponding depressed or raised relief, the inner face of the differential housing and the outer face of the blocking member preferably being provided with corresponding longitudinally extending splines which allow a relative longitudinal sliding movement and prevents a relative rotational movement around the longitudinal axis between the blocking member and the differential housing.

7. The assembly according to claim 1, characterized in that the or each through portion of the connecting device is engaged in a through opening provided in the peripheral wall of the differential housing, said through portion being capable of axially sliding in said through opening, which is preferably elongated in the longitudinal direction, and being rotatably fixed relative to the differential housing.

8. The assembly according to claim 7, characterized in that the blocking member comprises at least one receiving portion of the or each through portion of the connecting device, preferably in the form of a through aperture provided in a peripheral wall of the blocking member.

9. The assembly according to claim 8, characterized in that the or each through aperture is elongated circumferentially.

10. The assembly according to claim 1, characterized in that the outer portion of the connecting device comprises an inner face provided with at least one raised or depressed relief and in that an outer face of the differential housing is provided with at least one corresponding depressed or raised relief, preferably in the form of at least two protrusions, which are circumferentially spaced relative to one another and which project from the inner face of the connecting device outer portion, and at least two cavities which extend axially, which are circumferentially spaced relative to one another and which are arranged on the differential housing outer face, in order to allow a relative longitudinal sliding movement and prevent a relative rotational movement around the longitudinal axis between the differential housing and the outer portion of the connecting device.

11. The assembly according to claim 1, characterized in that the outer portion of the connecting device comprises at least one receiving portion of the or each through portion of the connecting device, preferably in the form of a hole or an inner annular groove.

12. The assembly according to claim 1, characterized in that the outer portion of the connecting device comprises an outer face provided with an outer annular groove or an outer annular ridge for receiving part of the actuation device.

13. The assembly according to claim 12, characterized in that the actuation device and the outer portion of the connecting device are free to rotate around the longitudinal axis relative to one another, the actuation device comprising at least one finger engaged in the outer annular groove of the connecting device outer portion, or one hollow portion for receiving the outer annular ridge of the connecting device outer portion.

14. The assembly according to claim 1, characterized in that the at least one through portion of the connecting device comprises at least two pins extending radially, preferably four and more preferably eight pins regularly angularly spaced.

15. The assembly according to claim 1, characterized in that it further comprises a support member configured to be axially maintained between the differential side gear and an inner collar of the differential housing, and further forming an inner abutment for preventing a radial inward movement of the or each through portion of the connecting device.

16. A differential unit of a vehicle, the differential unit comprising a differential carrier housing, and, mounted in said differential carrier housing:
an assembly according to claim 1;
a crown wheel having a longitudinal axis, arranged to be driven in rotation around said longitudinal axis by an input shaft;
a differential arranged substantially inside the crown wheel and comprising differential side pinions which rotates relative to a joint cross attached to the crown wheel and two differential side gears each connected to at least one differential side pinion and to a drive shaft capable of being connected to a wheel of a vehicle, outside the differential carrier housing;
a differential housing arrangement containing the differential and part of the drive shafts, said differential housing arrangement comprising two differential housings each secured to the crown wheel, on both sides of the crown wheel, the differential housings having the same longitudinal axis as the crown wheel;
wherein one differential housing and the differential side gear located inside said differential housing are part of said assembly.

17. The differential unit according to claim 16, characterized in that the actuation device is mounted on the differential carrier housing in a rotationally fixed manner.

18. The differential unit according to claim 16, characterized in that the blocking system is located inside the differential carrier housing, in an area substantially facing one differential housing along a direction orthogonal to the longitudinal axis.

19. The differential unit according to claim 16, characterized in that the blocking member is ring-shaped and is preferably arranged around one drive shaft.

20. The differential unit according to claim 16, characterized in that it further comprises, on either side of the crown wheel, a supporting device which is attached to the differential carrier housing and which comprises a ring-shaped portion in which is received part of one drive shaft inside a differential housing and a bearing surrounding the differential housing, the blocking member being located, according to a projection along the longitudinal axis, between the differential side gear and the corresponding bearing.

21. A driven wheel system for a vehicle, comprising at least one left wheel and one right wheel, each wheel being connected to a differential unit according to claim 16 by means of a drive shaft, at least one joint, a lower arm articulated at both ends and preferably an upper arm articulated at both ends.

22. A driven wheel system for a vehicle, the driven wheel system forming an axle and comprising:
a differential unit according to claim 16;
an axle housing which constitute a second housing portion designed to be assembled to a first housing portion for forming the differential carrier housing, and which at least partially contains the drive shafts;
at least one wheel connected to one end of each drive shaft.

23. A vehicle comprising at least one driven wheel system according to claim 21.
